(19) United States
(12) Patent Application Publication
(10) Pub. No.: US 2005/0285560 A1
(43) Pub. Date: Dec. 29, 2005

(54) Battery charger with secondary outlet

(76) Inventors: Kevin L. Glasgow, Lomira, WI (US); David J. Rozwadowski, Greenfield, WI (US); Jeffrey M. Zeiler, Pewaukee, WI (US)

Correspondence Address: MICHAEL BEST & FRIEDRICH, LLP, 100 E WISCONSIN AVENUE, MILWAUKEE, WI, 53202, US

(21) Appl. No.: 10/880,997

(22) Filed: Jun. 29, 2004

(51) Int. Cl. H02J 7/02

(52) U.S. Cl. 320/111

(57) ABSTRACT

An electrical device, such as a battery charger, including a housing having an outer surface, a battery being supportable on the outer surface, a charging circuit supported by the housing and electrically connectable to a power source and to the battery, and an electrical connector with a plug configured to interface with the power source and an outlet to provide an interface with the power source.

### FIELD OF THE INVENTION

The present invention generally relates to electrical devices and, more particularly, to electrical devices providing an interface to a power source.

### BACKGROUND OF THE INVENTION

Typically, electrical equipment, such as, for example, a cordless power tool, is powered by a rechargeable battery. The battery can be periodically charged by a battery charger. Existing battery chargers receive power to recharge the battery from a power source. The existing battery chargers can interface with the power source through a plug connectable to an outlet of the power source. Existing battery chargers receive power from the power source by connecting the plug of the charger to an outlet of the power source, such as an alternating current outlet.

### SUMMARY OF THE INVENTION

One independent problem with existing battery chargers is that when interfacing the plug of the existing battery charger with the outlet of the power source, the outlet of the power source is no longer available to other electrical devices. If an electrical device configured to interface with the power source through the outlet requires power from the power source, existing battery chargers have to be unplugged to free up the outlet for the electrical device. Unplugging the battery charger delays the charging of the battery. Alternatively, the electrical device can to wait until the existing battery charger has completed charging the battery, but this delays use of the electrical device.

The present invention provides a battery charger that overcomes the above-described problem. In some aspects and in some constructions, the present invention provides a battery charger that interfaces with an outlet of a power source and provides another interface to the power source. In some aspects, the interface to the power source provided by the battery charger has similar characteristics as the outlet directly provided by the power source.

More particularly, in some aspects and in some constructions, the present invention provides a battery charger including a housing with an outer surface capable of supporting a battery, a charging circuit supported by the housing and electrically connectable to a power source and to the battery, and an electrical connector having a plug configured to interface with the power source and having an outlet configured to provide an interface with the power source.

Also, in some aspects and in some constructions, the present invention provides a first electrical device including means for charging a battery, means for receiving electrical power, and means for providing the received electrical power, unmodified, to a second electrical device configured to interface with the first electrical device. In some aspects, the first electrical device and the second electrical device are different types of electrical devices.

In addition, in some aspects and in some constructions, the present invention provides a system for charging a battery including a battery charger that includes a housing with an outer surface, a charging circuit supported by the housing and electrically connectable to a power source and the battery, and a plug connectable to the power source and providing an outlet configured to provide an interface to the power source. The system further includes an electrical device connectable to the outlet.

Further, in some aspects and in some constructions, the present invention provides a electrical component usable with a power tool battery including a housing, a charging circuit electrically connectable to a power source capable of providing electrical power to the power tool battery, and a plug electrically connectable to the power source and configured to receive electrical power from the power source and configured to provide, unmodified, the electrical power provided by the power source.

Independent features and independent advantages of the invention will become apparent to those skilled in the art upon review of the detailed description and drawings.

### BRIEF DESCRIPTION OF THE DRAWINGS

FIG. 1 is a front perspective view of an electrical device, such as a battery charger assembly, embodying the present invention.

FIG. 2 is a top view of an electrical device, such as the electrical device of FIG. 1.

FIG. 3 is a side view of an electrical device, such as the electrical device of FIG. 1.

FIG. 4 is a back view of an electrical device, such as the electrical device of FIG. 1.

FIG. 5 is a front perspective view of a power cord of an electrical device, such as the electrical device of FIG. 1.

FIG. 6 is a side view of a power cord, such as the power cord of FIG. 5.

FIG. 7 is a top view of a power cord, such as the power cord of FIG. 5.

FIG. 8 illustrates an electrical device, such as the electrical device of FIG. 1 and an outlet to a power source.

FIG. 9 illustrates an electrical device, such as the electrical device of FIG. 1, connected to an outlet of a power source.

FIG. 10 illustrates an electrical device, such as the electrical device of FIG. 1, connected to an outlet of a power source and connected to a second electrical device, such as a radio.

FIG. 11 illustrates an electrical device, such as the electrical device of FIG. 1, connected to an outlet of a power source and connected to a second electrical device, such as a power tool.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

### DETAILED DESCRIPTION

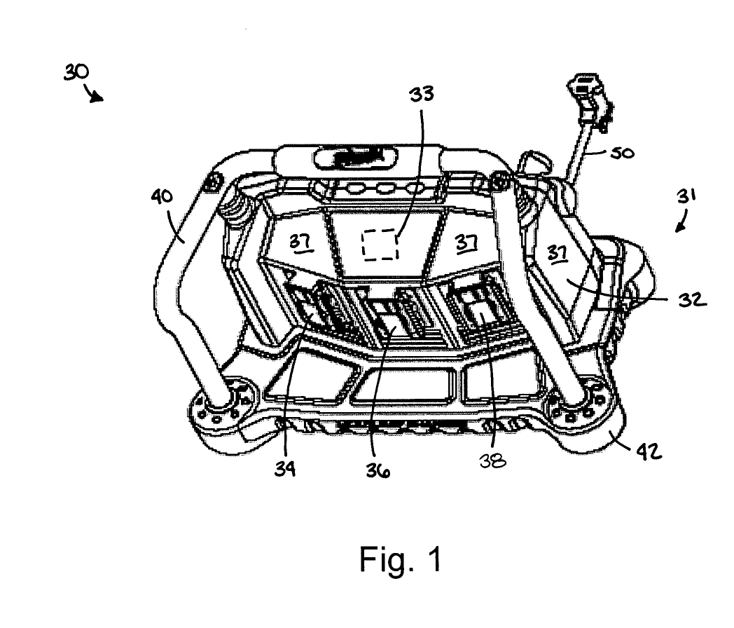

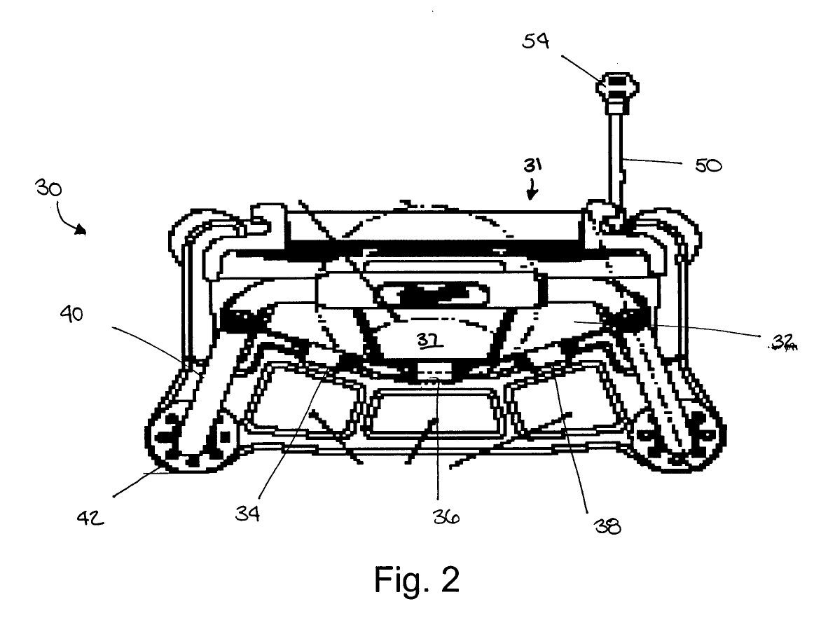

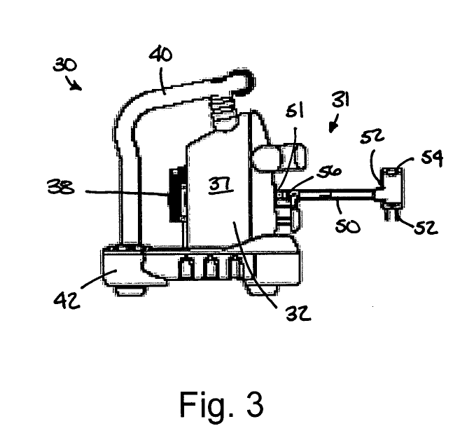

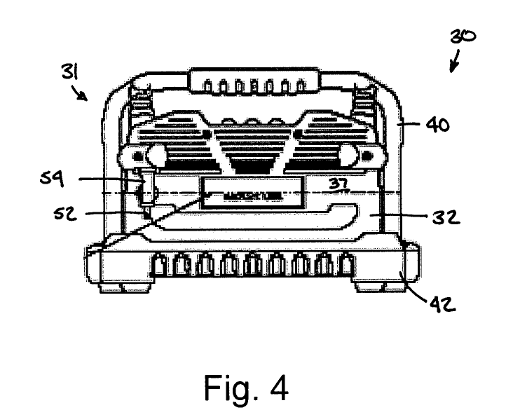

An electrical device 30 embodying aspects of the invention is illustrated in FIGS. 1-4. In some constructions and in some aspects, the electrical device 30 can include a battery charger assembly, such as the battery charger assembly 31 shown in FIGS. 1-4. In other constructions, the electrical device 30 can include other devices, such as, for example, various power tools (e.g., driver drills, circular saws, reciprocating saws, and the like), flood lights, radios, household appliances (e.g., vacuums, coffee pots, toasters) and the like.

In some constructions and in some aspects, the electrical device 30 includes a housing. As illustrated in FIGS. 1-4, for example, the electrical device 30 (e.g., the battery charging assembly 31) can include a housing 32. In some constructions, the housing can be constructed from a durable material and can protect the circuitry and other components included in the electrical device 30 from debris and contaminants. For example, as shown in the illustrated construction of FIG. 1, the housing 32 included in the battery charger assembly 31 substantially encloses a charging circuit 33 (shown schematically in FIG. 1).

In the illustrated constructions, the housing 32 of the battery charger assembly 31 can include an outer surface 37 which can at least partially support one or more batteries. The battery charger assembly 31 illustrated in FIGS. 1-4 is configured to support and charge three batteries and includes three battery receptacles 34, 36, and 38. However, in other constructions (not shown), the battery charger assembly 31 may support and charge any number of batteries.

In some constructions, the battery charger assembly 31 can be configured to charge a number of different battery chemistries, such as, for example, nickel metal hydride (“NiMH”) batteries, nickel cadmium (“NiCd”) batteries, lithium ion (“Li-ion”) batteries, and sealed lead acid (“SLA”) batteries. The battery charger assembly 31 can also be configured to charge a number of different battery voltages, such as, for example, 12 volts, 18 volts, 21 volts, 24 volts and the like.

As shown in the illustrated constructions, the battery charging assembly 31 can further include a handle 40 and a base 42. The handle 40 can be used to move and/or carry the battery charging assembly 31, with or without batteries connected. The base 42 and handle 40 can be constructed such that if the battery charger assembly 31 was to fall or shift positions, the battery charger assembly 30 would not roll or shift causing the batteries to be unintentionally removed from the battery receptacles 34, 36, and 38.

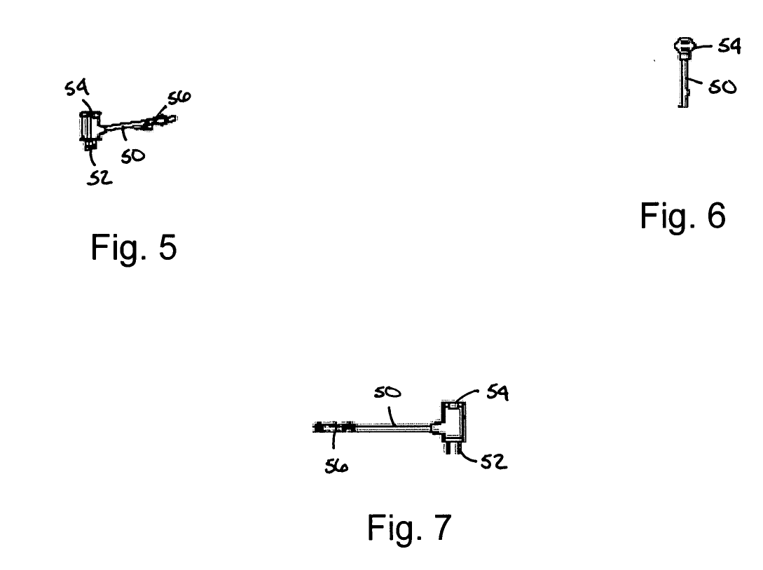

In some constructions, the electrical device 30 also includes an electrical connector 50. FIGS. 5-7 illustrate an exemplary electrical connector 50. In the illustrated constructions, the electrical connector 50 includes a power cord. In some constructions and in some aspects, the electrical connector 50 can include, without limitation, a power cord wired to the electrical device 30, a removable power cord, and the like. In other constructions, the electrical connector 50 can include a power cord with a quick-lock connection, such as the power cord shown and described in U.S. provisional application Ser. No. 60/523,541, the entire content of which is hereby incorporated by reference.

In the illustrated constructions, the electrical connector 50 provides an electrical coupling between a power source and the electrical device 30. In the illustrated constructions of Figs., the electrical connector 50 provides an electrical coupling between an outlet configured to conduct AC current and the

The power cord 50 can have various types of gages, insulating materials, and internal wire and conductor configurations and compositions, as is known in the art. In some constructions, the power cord 50 is an 18 gage power cord with polyvinyl chloride insulation. It should be apparent to one skilled in the art that other constructions are also possible. The electrical connector 50 can also have a variable length allowing the electrical device 30 to receive power from the power source over a range of distances. In other constructions, the electrical connector 50 can further be configured to withstand harsh environments including outdoor environments and environments containing dust and debris.

As shown in Figs. XX, a first end 51 of the electrical connector 50 can be connectable to the electrical device 30 (e.g., the battery charger assembly 31) and, more specifically, can be connectable to a circuit contained within the housing of the electrical device 30 (e.g., the charging circuit 28 of the battery charger assembly 31). In some constructions, the electrical connector 50 is configured to supply an 120-V AC signal to the electrical device 30 and includes two internal wires, such as, for example, a power wire (not shown) and a neutral wire (not shown). In other constructions, the electrical connector 50 may further include additional wires, such as, for example, a ground wire (not shown) and/or a second power wire (not shown), and be configured to supply another AC signal, such as, for example, a 240-V AC signal. In some constructions where the battery charger 30 includes a number of charging circuits 28, the power wire(s), the ground wire(s) and/or the neutral wire(s) can be spliced and relayed to provide power and grounding to each of the charging circuits. The power received from the power source through the power cord 50 can be utilized by the charging circuit of the battery charger to charge a battery docked at a battery receptacle such as 34, 36, and 38.

The first end 51 of the electrical connector 50 can include a cord strain relief 56 that allows the electrical connector 50 to be bent and flexed without pinching or cracking the connector 50 or causing the connector 50 to become disengaged with the electrical device 30.

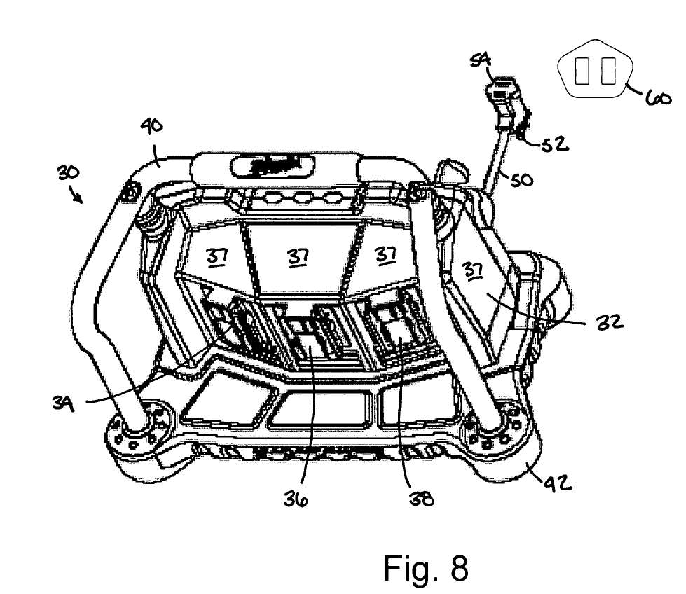

In some constructions and in some aspects, the electrical connector 50 contains an input terminal 52 at the second end 53 of the connector 50. In other constructions, the input terminal 52 may be located at other locations of the electrical connector 50. In the illustrated constructions, the input terminal 52 is a two-prong plug and is configured to interface with a power source. For example, the plug 52 may be mechanically and electrically configured to interface with an outlet of a power source. In some aspects, the outlet of a power source can be an AC outlet located on a wall or floor, such as outlet 60 illustrated in FIG. 8.

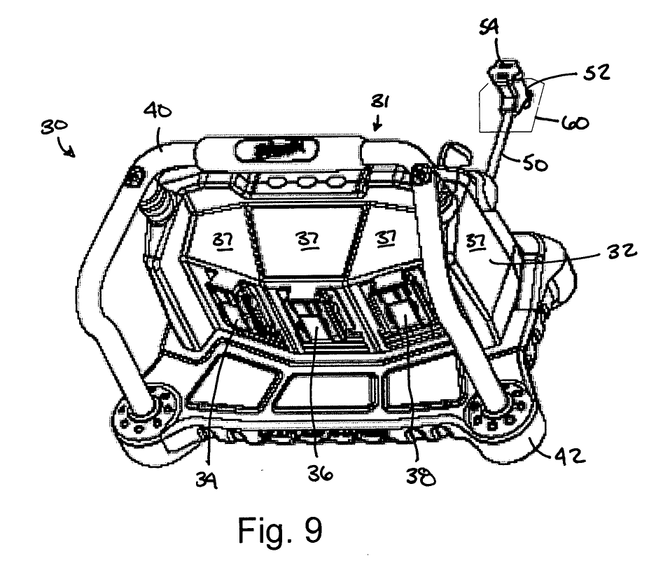

When interfaced with the outlet 60, as illustrated in FIG. 9, the plug 52 can receive power and transmit the power through the electrical connector 50 to the electrical device 30. As stated previously, in some constructions, the plug 52 contains two prongs in a National Electrical Manufacturers Association (“NEMA”) 1-15 configuration. The two prongs can be constructed by polarized tin plated brass, although other configurations are possible that include more or fewer prongs and different prong configurations and compositions. In some constructions, the plug 52 is configured to accept a given amount of power from the power source. For example, in some constructions, the plug 52 is configured to accept a range of power levels including 120 volts. The power accepted or received by the plug 52 may be regulated to ensure that the battery charger 30 receives enough power to operate properly without receiving too much power that may damage or inhibit the performance of the charging circuit of the battery charger 30.

As shown in the illustrated constructions, the second end 53 of the electrical connector 50 further includes a secondary outlet 54. In other constructions, the outlet 54 can be located at various locations on the electrical connector 50 or the housing of the electrical device 30.

As shown in the illustrated constructions, when the plug 52 interfaces with the outlet 60 of the power source, the secondary outlet 54 can be configured to provide an alternate interface to the power source since the outlet 60 is being utilized by the plug 52 of the battery charger. The secondary outlet 54 can allow the power provided by the power source to pass through the plug 52 of the electrical device 30 and be available for a second electrical device, as discussed below. The secondary outlet 54 may provide an identical interface as the outlet 60 directly provided by the power source, or may provide an alternate or modified interface. For example, the secondary outlet 54 can provide a mechanically different interface than the outlet 60 directly provided by the power source. For example, the secondary outlet 54 can provide an interface for a plug or other electrical connector that is not configured to interface with the outlet 60 of the power source. Furthermore, the secondary outlet 54 can provide a different power signal than the power signal supplied by the first outlet 60 of the power source. In one construction, for example, the outlet 60 of the power source can be configured to supply a 240-V AC signal, yet the second outlet 54 of the electrical device 30 can be wired and configured to supply a 120-V AC signal. In other constructions, the electrical connector 50 can include a converting circuit (not shown) to convert the AC power signal supplied by the outlet 60 of the power source to a DC power signal, such as, for example, a 12-V DC signal.

The secondary outlet 54 can exploit power received by the input terminal 52 and can provide power to another electrical device configured to interface with the secondary outlet 54. For example, if the electrical device 30 is connected to the power source via the wall outlet 60 and a user desires to connect a second electrical device to the wall outlet 60, the user can plug the second electrical device into the secondary outlet 54 of the electrical device 30. In this example, the second electrical device receives power from the outlet 60 of the power source via the secondary outlet 54.

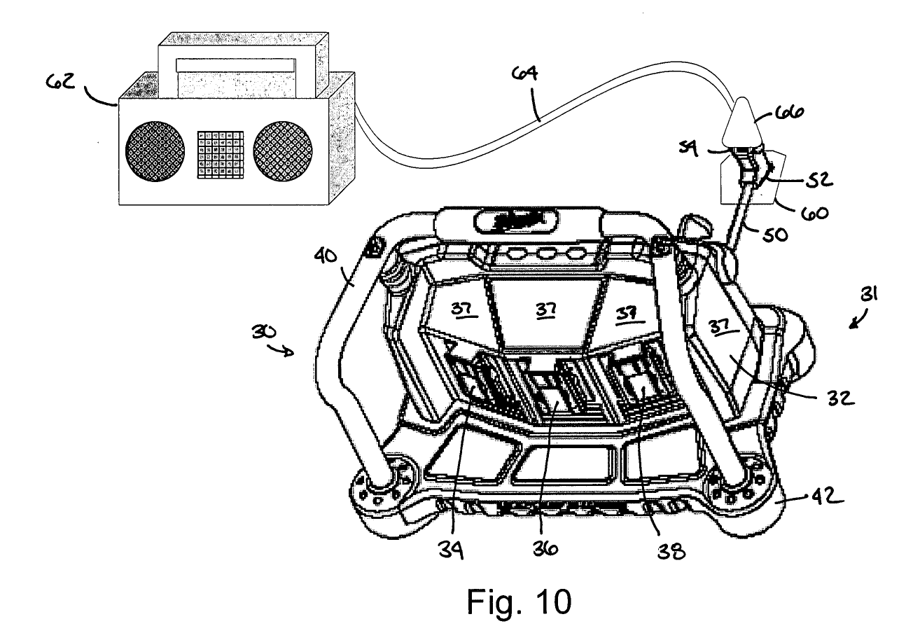

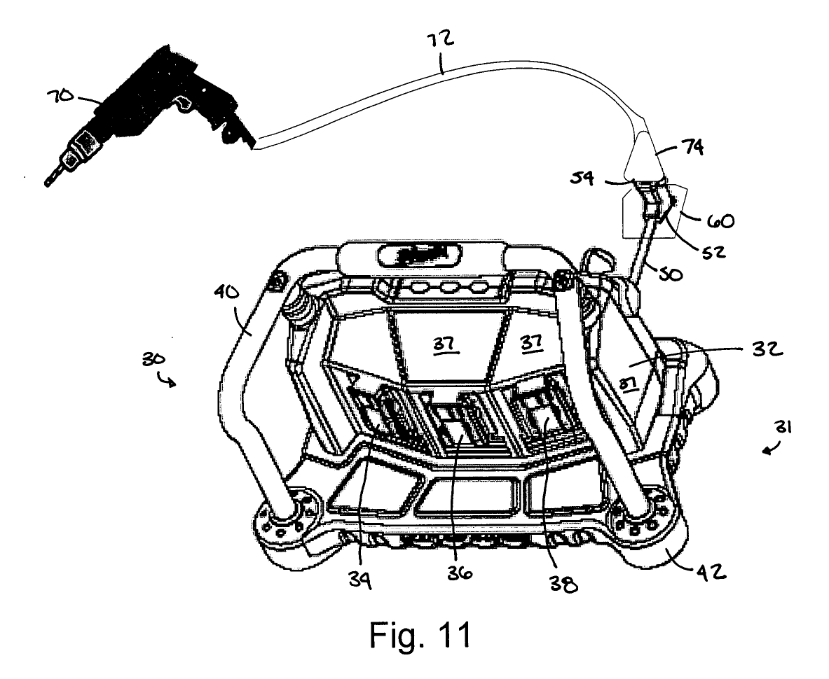

FIG. 10 illustrates the battery charger 31 connected to the outlet 60 and an electrical device embodied as a radio 62 connected to the secondary outlet 54 provided by the battery charger 31. A power cord 64 of the radio 64 contains a plug 66 that interfaces with the secondary outlet 54 provided by the power cord 50 of the battery charger assembly 31. Similarly, FIG. 11 illustrates the battery charger assembly 31 connected to the outlet 60 and an electrical device embodied as a power drill 70 connected to the secondary outlet 54. A power cord 72 of the power drill contains a plug 74 at one end that interfaces with the secondary outlet 54 provided by the battery charger 31. In the constructions illustrated in FIGS. 10 and 1, the secondary outlet 54 allows both the battery charger 31 and an electrical device, such as the radio 62 and power drill 70, to receive the necessary power to operate from the power source although a single outlet 60 is provided by the power source.

In some aspects and in some constructions, the secondary outlet 54 provides an unmodified interface to the power source. For example, if the outlet of the power source, such as a wall outlet 64, provides access to up to 240 volts of electricity, the outlet 54 contained on the power cord 50 of the battery charger 30 can provide access to the same electricity minus the electricity or power consumed by the battery charger assembly 31. In some constructions, the battery charger 30 consumes 120 volts of electricity. Similarly, if the outlet 60 of the power source provides an AC current, the outlet 54 also provides an AC current.

As previously indicated, in some aspects and in some constructions, the secondary outlet 54 may be positioned at other locations of the electrical device 30. For example, the secondary outlet 54 can be contained in the housing of the electrical device 30, or, more specifically, can be incorporated into the handle 40 or base 42. In some constructions, the electrical device 30 can provide more than one secondary outlet 54. The multiple secondary outlets 54 may be identical outlets 54 or may vary to provide a number of interfaces to the power source. It should be apparent to one skilled in the art that other features may be provided in conjunction with the secondary outlet 54. For example, the power cord 50 or plug 52 can include a switch (not shown) that regulates the operation of the secondary outlet 54. The switch can be configured to connect and disconnect the secondary outlet 54 from the power source or may be used to set a power range or limit of the power provided through the secondary outlet 54. The power cord 50 can further include one or more adapters configured to interface with the secondary outlet 54 and provide an alternate outlet or interface. The adapters can be used to interface or connect a variety of electrical devices that have varying plug configurations. The switch and/or adapters may also be contained directly on the electrical device 30, such as, for example on the housing 32 of a battery charger assembly 31.

Although particular constructions of the present invention have been shown and described, other alternative constructions will be apparent to those skilled in the art and are within the intended scope of the present invention.

1. A battery charger comprising:
a housing having an outer surface, a battery being supportable on the outer surface;
a charging circuit supported by the housing and electrically connectable to a power source and to the battery; and
an electrical connector with a plug configured to interface with the power source and an outlet to provide an interface with the power source.

2. The battery charger as set forth in claim 1, wherein the outlet provides an unmodified interface with the power source.

3. The battery charger as set forth in claim 1, wherein the electrical connector is a power cord.

4. The battery charger as set forth in claim 1, wherein the power source supplies AC power.

5. The battery charger as set forth in claim 1, wherein the power source supplies 120 volts of electricity to the battery charger.

6. A battery charger comprising:
a housing having an outer surface, a battery being supportable on the outer surface;
a charging circuit supported by the housing and electrically connectable to a power source and to the battery;
a plug configured to receive electrical power from the power source; and
an outlet configured to provide the electrical power received by the plug to a device detachable from the battery charger.

7. The battery charger as set forth in claim 6, further comprising an electrical connector configured to contain the plug and the outlet.

8. The battery charger as set forth in claim 8, wherein the electrical connector is a power cord.

9. The battery charger as set forth in claim 8, wherein the plug and the outlet are contained on an end of the power cord.

10. The battery charger as set forth in claim 9, wherein the plug and the outlet are contained on opposite surfaces of the end of the power cord.

11. The battery charger as set forth in claim 6, wherein the electrical power provided through the outlet is the same power received by the plug.

12. The battery charger as set forth in claim 6, wherein the electrical power is AC power.

13. The battery charger as set forth in claim 6, wherein the electrical power is 240 volts.

14. A first electrical device, the first electrical device comprising:
means for charging a battery;
means for receiving electrical power; and
means for providing the received electrical power, unmodified, to a second electrical device configured to interface with the first electrical device.

15. The first electrical device as set forth in claim 14, wherein the first device and the second device are different types of devices.

16. The first electrical device as set forth in claim 15, wherein the first device and the second device are the same type of device.

17. The first electrical device as set forth in claim 15, where the electrical power is AC power.

18. A system for charging a battery the system comprising:
a battery charger including
a housing having an outer surface,
a charging circuit supported by the housing and electrically connectable to a power source and the battery, and
a plug connectable to the power source, the plug having
an outlet configured to provide an interface to the power source; and
an electrical device connectable to the outlet.

19. The system as set forth in claim 18, wherein the plug receives electrical power from the power source when connected.

20. The system as set forth in claim 19, wherein the outlet provides electrical power and the electrical power is unmodified from the electrical power received by the plug.

21. The system as set forth in claim 20, wherein the electrical device not configured to charge a battery is connectable to the outlet through a second plug coupled to the electrical device.

22. The system as set forth in claim 19, wherein the electrical power received from the power source is AC power.

23. The system as claimed in claim 18, wherein the battery charger further includes a power cord containing the plug and outlet.

24. An electrical component usable with a power tool battery, the electrical component comprising:
a housing;
a charging circuit electrically connectable to a power source capable of providing electrical power to the power tool battery;
a plug electrically connectable to the power source and configured to receive electrical power from the power source, the plug including
an outlet connectable to the power source through the plug and configured to provide, unmodified, the electrical power provided by the power source.

25. The electrical component as set forth in claim 24, further comprising a power cord containing the plug.

26. The electrical component as set forth in claim 25, wherein the power cord further contains the outlet.

27. The electrical component as set forth in claim 24, wherein the outlet is connectable with a second plug of a second electrical component.

28. The electrical component as set forth in claim 24, wherein the power source provides AC power.

29. The electrical component as set forth in claim 28, wherein the outlet provides AC power.

30. An electrical device, the device comprising:
a charging circuit electrically connectable to a power source capable of providing electrical power to a battery;
a plug electrically connectable to the power source and configured to receive electrical power from the power source;
an outlet configured to provide, unmodified, the electrical power received by the plug.

31. The electrical device as set forth in claim 30, further comprising a power cord containing the plug.

32. The electrical device as set forth in claim 31, wherein the power cord further contains the outlet.

33. The electrical device as set forth in claim 30, wherein the power source provides AC power to the battery.

34. The electrical device as set forth in claim 33, wherein the outlet provides AC power.

35. The electrical device as set forth in claim 30, wherein the power source provides 120 volts of power to the electrical device.

36. The electrical device as set forth in claim 30, wherein the outlet is further configured to accept a second plug from a second electrical device.

37. An electrical component usable with a power tool battery, the electrical component comprising;
a housing;
a charging circuit electrically connectable to a power source capable of providing electrical power to the power tool battery; and
an outlet capable of supplying electrical power to an electrical device.

38. The electrical component set forth in claim 37, wherein the power source provides AC power to the battery.

39. The electrical component as set forth in claim 37, wherein the outlet provides AC power to the electrical device.

40. The electrical component as set forth in claim 37, wherein the power supplied to the electrical device by the outlet is the same power supplied to the battery by the power source.

41. The electrical component as set forth in claim 37, wherein the power source provides 120 volts of power to the electrical component.

42. The electrical component as set forth in claim 37, further comprising a power cord connectable to the power source.

43. The electrical component as set forth in claim 42, wherein the power cord contains the outlet.

44. The electrical component as set forth in claim 37, wherein the outlet is further configured to accept a plug from the electrical device.
